(19) United States
(12) Patent Application Publication
(10) Pub. No.: US 2005/0106910 A1
(43) Pub. Date: May 19, 2005

(54) Thumbnail size flash memory card connector

(76) Inventor: Hsien-Yu Chiu, Taoyuan (TW)

Correspondence Address: P-Two Industries Inc., P.O. Box No. 6-57, Junghe, Taipei, 235, TW

(21) Appl. No.: 10/825,284

(22) Filed: Apr. 16, 2004

(30) Foreign Application Priority Data
Nov. 13, 2003 (TW) 092131863

(51) Int. Cl. H01R 13/44

(52) U.S. Cl. 439/136

(57) ABSTRACT

A thumbnail size flash memory card connector including an insulator, a moveable cover and eleven connecting terminals. An opening recess and a mis-insert-proof structure are configured on the insulator of the connector, therewith enabling containment of a signal contact portion of a miniSD memory card therein, and therewith prevents inserting the signal contact portion in a wrong direction. The connector utilizes press-fit strips configured on the movable cover to directly press-fit onto slideways configured on two sides of the signal contact portion of the miniSD memory card, thereby firmly securing the signal contact portion of the miniSD memory card, and constituting a good electrical connection with contact terminals of the connector.

### BACKGROUND OF THE INVENTION

(a) Field of the Invention

The present invention relates to a flash memory card connector, and more particularly to a connector for exclusive use by a thumbnail size flash memory card (miniSD memory card).

(b) Description of the Prior Art

A new miniSD flash memory card (mini Secure Digital Card) having dimensions 20 mm×21.5 mm×1.4 mm, and with area approximately equal to half that of a thumb is enabled to provide 11 signal lines, as well as a current storage capacity of 256 megabytes (MB). When compared to 9 signal lines of a general SD memory card, the miniSD flash memory card is able to save on area required by a printed—circuit board of current SD memory cards by over 40%. When devised for usage in portable devices, the miniSD flash memory card is able to save on physical space required for installation of current SD memory cards by over 60%. Furthermore, an additional 2 signal lines of the miniSD flash memory card are in readiness for utilization of future expansion features, for instance, the additional signal lines can be utilized to link up with non-contact IC short-range wireless communication aerials.

The miniSD flash memory card being of light and handy size, and providing significant saving on surface area and physical dimensions is already subject to extensive research and development for usage in mobile phones and palmtop type electronic products, particularly integration into mass data storage of mobile phones. Furthermore, SD interface employed is identical to the SD interface employed in current SD memory cards. The miniSD flash memory card is compatible with all hardware or software, thus the USA SD Card Association has already publicly announced approval of the miniSD flash memory card standard, and which has been agreed upon as a standard compliance for current SD memory cards.

Furthermore, once the mobile phones commence usage of the miniSD memory card for data storage therein, not only will storage capacity increase, but also will provide people with familiar multimedia functionality, for instance, providing the mobile phone with a digital camera and video capability, playing of MP3 and video games, personal information management (PIM), e-mail and voice-mail, Internet access, and so on. In addition, light and small nature of the miniSD memory card accords with market demands for miniaturization of the mobile phone.

In light of aforementioned, in order to cater for trend in future extensive employment of the miniSD memory card, the inventor of the present invention expressively followed specifications of the miniSD memory card and invented a connector for exclusive use by the miniSD memory card.

### SUMMARY OF THE INVENTION

Therefore, a primary objective of the present invention is to provide a connector for exclusive use by a thumbnail size flash memory card (miniSD memory card), and thereby be extensively integrated into multi-media mobile phones, digital cameras, MP3 players, recorders and navigation systems, thus enabling such devices to utilize the miniSD for storing data. In particular, the connector of the present invention can be integrated into the mobile phone, thereby enabling the mobile phone to be provided with functionality for provision of the digital camera, Internet access, and so on.

A second objective of the present invention is to provide a connector for exclusive use by a thumbnail size flash memory card (miniSD memory card) and structured to comprise an insulator, a moveable cover and eleven connecting terminals. Pursuant to standard specifications of the miniSD memory card, an opening recess and a mis-insert-proof protective structure are able to contain a signal contact portion of the miniSD memory card, and therewith prevent inserting the signal contact portion in a wrong direction. Furthermore, the connector utilizes press-fit strips configured on the moveable cover to directly press-fit onto slideways configured on two sides of the signal contact portion of the miniSD memory card, thus firmly securing the signal contact portion of the miniSD memory card within the opening recess of the insulator of the connector, and thereby constituting a good electrical connection with the contact terminals of the connector.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a general view of a miniSD memory card connector according to the present invention.

FIG. 2 shows a schematic elevational view of a moveable cover of the miniSD memory card connector being pulled away according to the present invention.

FIG. 3 shows an exploded elevational view of components of the miniSD memory card connector according to the present invention.

FIG. 4 shows a front view of the moveable cover of the miniSD memory card connector depicting press-fit strips configured on a cover panel of the moveable cover by punch molding downward thereon, and tabs configured on the cover panel of the moveable cover by inwardly punch molding thereon according to the present invention.

FIG. 5 shows a cross sectional schematic view depicting the miniSD memory card connector of the present invention after utilizing blocking pieces configured on left and right sides of side panels of the moveable cover to lodge into slide grooves defined in left and right sides of an insulator respectively, and together with the insulator establishing a sliding mechanism therewith according to the present invention.

FIG. 6 shows a schematic view of the miniSD memory card connector in usage, whereby a gap having a wedge-shaped surface of the miniSD memory card being accurately aligned with a wedge-shaped gap of the insulator, thereby allowing correct placing of the miniSD memory card within an opening recess of the insulator according to the present invention.

FIG. 7 shows a schematic view of the miniSD memory card connector providing usage for the miniSD memory card according to the present invention.

FIG. 8 shows a top view of FIG. 7 according to the present invention.

FIG. 9 shows a partial enlarged cross sectional view of FIG. 8 along a 9-9 cross sectional axis depicting the miniSD memory card connector utilizing press-fit strips configured on the cover panel to directly press-fit onto slideways on two sides of a signal contact portion of the miniSD memory card according to the present invention.

### DETAILED DESCRIPTION OF THE PREFERRED EMBODIMENTS

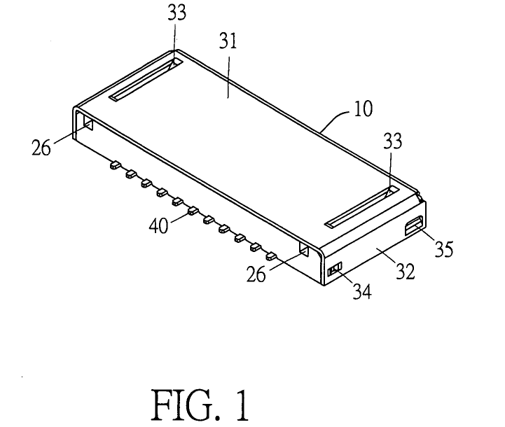

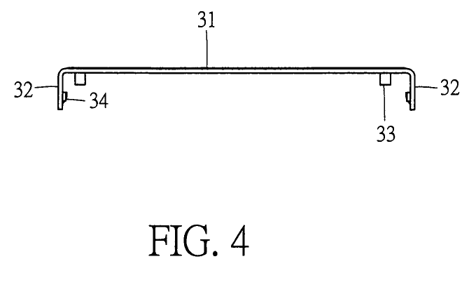

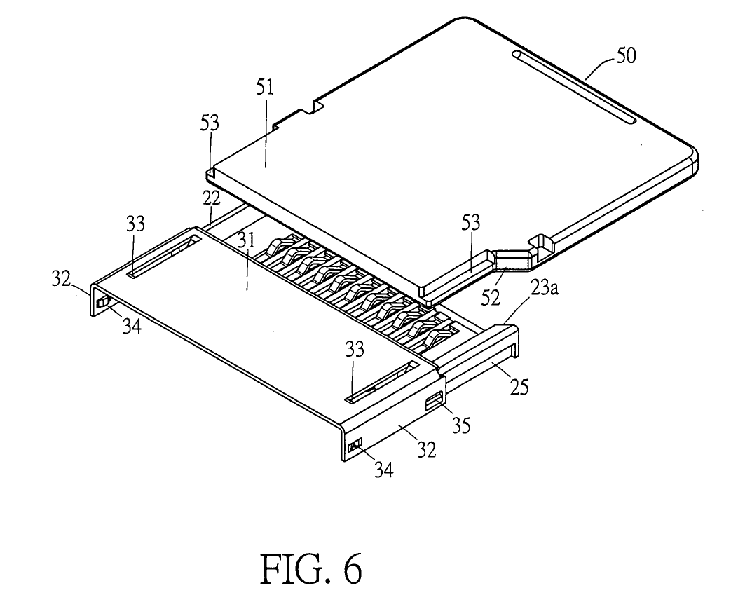

Referring to FIGS. 1, 2, 3 and 4, which show a miniSD memory card connector (10) of the present invention collectively configured to comprise a lengthwise insulator (20), a reverse U-shaped moveable cover (30), and 11 connecting terminals (40).

Wherein, the insulator (20) is provided with a downwardly sunken open space, wherewith constitutes an opening recess (21) of the insulator (20), and usage objective of the opening recess (21) is to provide placing of a signal contact portion (51) of the miniSD memory card (50) therein (see FIG. 6).

Referring to FIG. 6, with regard to the miniSD memory card (50) being configured with a mis-insert-proof structure, a gap having a wedge-shaped surface is defined in one side of the signal contact portion (51) to effectuate such, accordingly, taking views as depicted in accompanying FIGS. as being correct, ribs upwardly protrude in part from each of left and right sides of the opening recess (21) defined in the insulator (20) thereby forming a heightened right sidewall (22) and a heightened left sidewall (23) of the insulator (20) respectively. However, to accommodate the mis-insert-proof structure design of the miniSD memory card (50), the right sidewall (23) and the left sidewall (22) are configured to assume a non-mutually symmetrical structure, that is, wall thickness of the right sidewall (23) is thicker than that of the left sidewall (22). In addition, a front-end of the right sidewall (23) forms a wedge-shaped gap (23a), which thereby prevents wrongly inserting the signal contact portion (51) of the miniSD memory card into the opening recess of the insulator (20). Furthermore, a slide groove (25) is recessed in each surface of an outer wall of the left sidewall (22) and the right sidewall (23) respectively, and utilized to provide slide guides therewith. However, front and rear ends of the slide grooves (25) are not left open, but are sealed off, wherewith inhibiting formation of an opening.

Furthermore, taking views as depicted in accompanying FIGS. as being correct, a rear side of the opening recess (21) defined in the insulator (20) upwardly protrudes in part thereby forming a heightened platform, each side of which retains a spacing with the left sidewall (22) and the right sidewall (23) thereof. Apart from structuring a rear wall of the insulator (20), the platform also realizes a groove (26) to be defined between the left sidewall (22) and a rear wall (24), and a similar groove (26) to be defined between the right sidewall (22) and the rear wall (24).

Eleven grooves are defined in a surface of the opening recess (21) of the insulator (20), and eleven insertion slots are defined in the platform of the rear wall (24), which are utilized to provide for the eleven connecting terminals (40) to lodge thereinto, and thereby together ensure firm placement of the eleven connecting terminals (40) within the insulator (20) thereof.

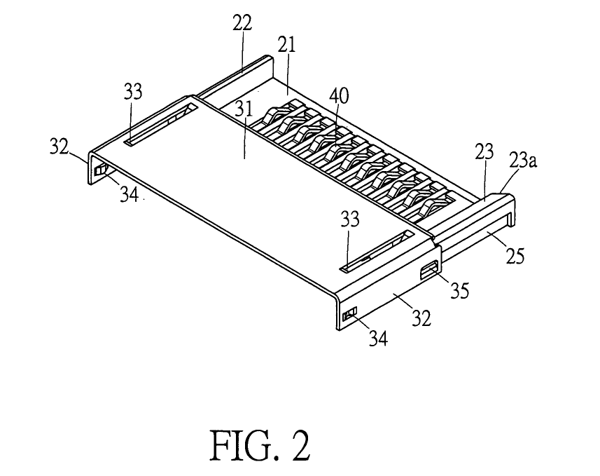

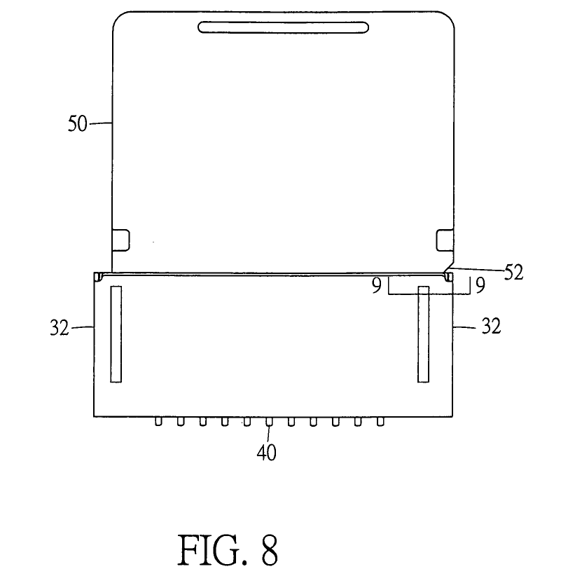

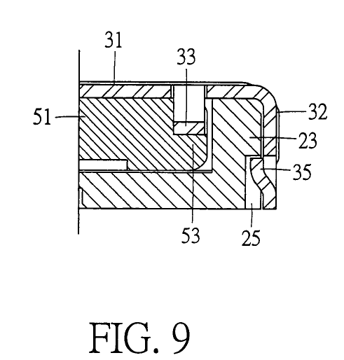

The movable cover (30) is made of metallic material, and is punch molded to form a reverse U-shaped body, and thereby provides a cover panel (31) and side panels (32) configured on left and right sides of the cover panel (31). Moreover, as depicted in FIGS. 2, 3, and 4, employing punch molding art, blocking pieces (35) and tabs (34) are configured by inwardly punch molding a front-end and a rear-end of each surface of the side panels (32) respectively, and press-fit strips (33) are configured on two sides of a surface of the cover panel (31) by punch molding downward thereon. However, depth of each of the punch-molded press-fit strips (33), and distance between the two press-fit strips (33), as depicted in FIG. 6, are in accordance with specifications of the miniSD memory card (50), accordingly, the depth of the punch-molded press-fit strips (33) are slightly deeper than depths of slideways (53) configured on two sides of the signal contact portion (51) of the miniSD memory card, and distance between the two press-fit strips (33) is slightly wider than narrowest distance of the slideways (53) on two sides of the signal contacts portion (51) of the miniSD memory card. Because front-ends and rear-ends of the press-fit strips (33) are joined to the surface of the cover panel (31), allowances are realized for slight transformation of middle sections of the press-fit strips (33), and thus the press-fit strips (33) are provided with elasticity therewith. Therefore, utilization is made of the elasticity of the two press-fit strips (33) to press-fit onto the slideways (53) on the two sides of the miniSD memory card, as depicted in FIGS. 8 and 9.

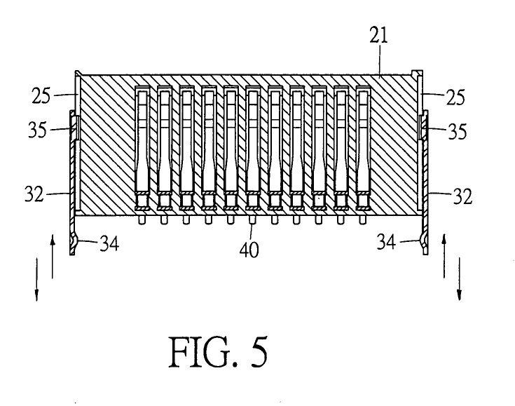

Hence, referring to FIGS. 2, 5, and 9, when the movable cover (30) utilizes the blocking pieces (35) on the front-end surfaces of the left and right side panels (32) to lodge into the slide grooves (25) of the left sidewall (22) and the right sidewall (23) of the insulator (20) respectively, together with the insulator (20) a sliding mechanism is thus established.

When the moveable cover (30) is pulled away, the blocking pieces (35) of the moveable cover (30) thereby correspondingly slide within the slide grooves (25) of the insulator (20); the press-fit strips of the movable cover (30) are also synchronously displaced within the grooves (26) of the insulator (20). Upon the movable cover (30) being pulled away till the blocking pieces (35) come in contact with sealed rear ends of the slide grooves (25), the opening recess (21) of the insulator (20) is thus completely revealed. Whereas, when the moveable cover (30) is being pushed back to cover up the insulator (20), the blocking pieces (35) of the moveable cover (30) come in contact with sealed front ends of the slide grooves (25) of the insulator (20). In addition, the tabs (34) on the rear-end surfaces of the side panels (32) of the left and right sides of the movable cover (30) are thereupon slotted within the slide grooves (25) of the insulator (20), thereby achieving effectiveness of anchoring position thereat, and thus the opening recess (21) of the insulator (20) is completely sealed by the cover panel (31) of the moveable cover (30).

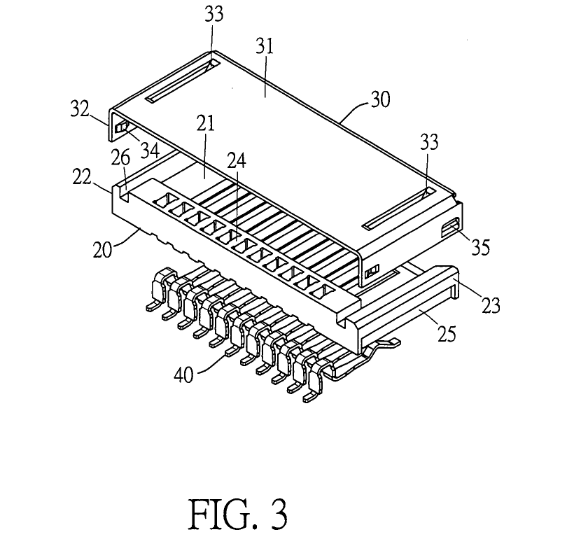

Referring to FIGS. 6, 7, 8 and 9, which show the miniSD memory card connector (10) of the present invention soldered onto a printed-circuit board of a mobile phone, thereby enabling the mobile phone to utilize the minis memory card to store data. In usage, as depicted in FIG. 6, the movable cover (30) is first pulled away in a straight line until the moveable cover (30) can no longer slide any further, thereat the opening recess (21) of the insulator (20) is completely revealed (as depicted in FIG. 3). Thereupon, the mis-insert-proof structure of the miniSD memory card, accordingly utilizes the gap having a wedge-shaped surface of the miniSD memory card (50) to ensure accurate aligning up with the wedge-shaped gap (23a) of the right sidewall (23) of the insulator (20), the miniSD memory card is thereby correctly placed within the opening recess (21) of the insulator (20).

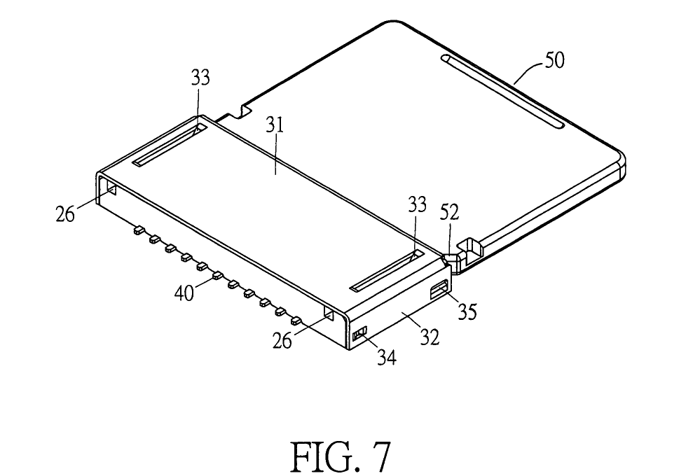

Thereafter, the moveable cover (30) is pushed over and thus secures positioning of the miniSD memory card (50), thereby utilizing the cover panel (31) to seal the signal contact portion (51) of the miniSD memory card (50), as depicted in FIGS. 7 and 8. Thereat, the tabs (34) on the side panels (32) of the left and right sides of the movable cover (30) slot within the slide grooves (25) of the insulator (20), thus achieving effectiveness of secure positioning of the movable cover (30). Furthermore, the press-fit strips (33) of the movable cover (30) press-fit onto the slideways (53) configured on two sides of the signal contact portion (51) of the miniSD memory card (50) respectively, as depicted in FIG. 9, thus realizing joining together of a structure while enabling the signal contact portion (51) of the miniSD memory card (50) and the connecting terminals (40) of the miniSD memory card connector (10) to constitute a good electrical connection therefrom, as well as firmly securing the miniSD memory card (50) within the opening recesses (21) of the insulator (20), thereby providing the mobile phone with multimedia functionality including having provision for a digital camera and video capability, playing of MP3, Internet access, and so on.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A thumbnail size flash memory card connector comprising a lengthwise insulator, a reverse U-shaped moveable cover, and a plurality of connecting terminals, wherein:
sidewalls on left and right sides of the insulator assume a non-mutually symmetrical structure, wherein a front-end of the sidewall having slightly thicker wall thickness is configured to form a wedge-shaped gap, moreover, a slide groove is respectively defined in each surface of an outer wall of the left sidewall and the right sidewall;
the reverse U-shaped moveable cover is provided with a cover panel and side panels configured on left and right sides of the cover panel, and blocking pieces are configured by punch molding each surface of the side panels of the moveable cover, and press-fit strips are configured on two sides of a surface of the cover panel by punch molding thereon; furthermore, the blocking pieces on the two side panels of the moveable cover lodge into slide grooves configured in left and right sides of the left and right sidewalls of the insulator respectively; and the connecting terminals, which lodge into the insulator and secure placement therein.

2. The thumbnail size flash memory card connector according to claim 1, wherein tabs are further configured by punch molding each surface of the side panels of the moveable cover.
